(19) United States
(12) Patent Application Publication
(10) Pub. No.: US 2006/0089103 A1
(43) Pub. Date: Apr. 27, 2006

(54) Wireless interference detector

(76) Inventor: James P. Osburn, Terre Haute, IN (US)

Correspondence Address: BAKER & DANIELS LLP, 300 NORTH MERIDIAN STREET, SUITE 2700, INDIANAPOLIS, IN, 46204, US

(21) Appl. No.: 10/972,685

(22) Filed: Oct. 25, 2004

(51) Int. Cl. H04B 17/00; H04B 1/26

(52) U.S. Cl. 455/67.13; 455/501

(57) ABSTRACT

A radio frequency (RF) source detector detects and analyzes RF signals in order to determine the source of interference. The source detector is useful for installing and troubleshooting a wireless local area network (WLAN) or similar communication devices. The detector includes a receiver to receive RF signals from unknown RF sources, a processor for determining the level and characteristics of the RF signals and for determining the identities of unknown RF sources, and a display on which the processor displays the identities of the RF sources.

### BACKGROUND OF THE INVENTION

1. Field of the Invention

The present invention relates to signal processors for detecting and analyzing radio frequency transmissions and interference.

2. Description of the Related Art

Oscilloscopes produce an instantaneous trace of a received signal on a display screen, such as a cathode ray tube. The instantaneous trace is generally displayed in terms of amplitude versus time and corresponds to variations in voltage or current over time, or, in the case of receiving a radio frequency transmission, corresponds to variations in amplitude and frequency over time. When displaying radio frequency signals, oscilloscopes therefore provide a display of the raw signal showing variations over time.

Signal and spectrum analyzers provide a display showing the power distribution of a signal across a range of frequencies. The display therefore shows the frequency or frequencies contained within the received signal. For reception of a radio frequency signal, a spectrum analyzer will display a signal peak at the carrier frequency of the radio frequency signal.

One known apparatus for identifying radio transmitters uses the transient frequency or phase history of the turn-on characteristics of a transmitter to classify an unknown transmitter. The apparatus includes a library of the phase rate of change of previously identified transmitters. However, the apparatus is dependent on the transient turn-on characteristics of the transmitter and does not receive and identify transmitters based on signal characteristics associated with a transmitter already on the air.

One problem with prior signal processors is that they provide raw data on a display which must be viewed and interpreted by a user. The variety of signal characteristics associated with various radio frequency sources creates great difficulty in identifying the source for any radio frequency signals. Known signal processors thus are quite limited in their ability to provide interpretation of transmission sources.

### BRIEF SUMMARY OF THE INVENTION

The present invention provides a radio frequency (RF) source detector for detecting and analyzing RF signals in order to identify the type of source of RF signals, including interference. The detector is useful for determining the sources of interference for installing or troubleshooting a wireless communication system, such as local area network (WLAN) or a short range wireless hub. The detector includes a receiver to receive RF signals in a predetermined band from unknown local RF sources, a processor for analyzing the RF signals and for determining identities of the unknown local RF sources, and a display on which the processor displays the identities of the local RF sources.

The detector is capable of analyzing the RF signals in both the time and frequency domain and examines signal characteristics, including minimum, maximum, and average signal levels for time domain samples and peak power frequency for frequency domain data. Based on the signal characteristics, the detector determines the source or sources of the RF signals, including such devices as a WLAN, a video transmitter, a microwave oven, a cordless phone, and a short range wireless device, such as a Bluetooth™ device (Bluetooth™ is a trademark owned by Bluetooth SIG, Inc.).

The detector is also capable of collecting and calculating data sets of samples, statistics, and fast fourier transforms (FFTs) of the radio frequency signals. The data sets may be stored in the detector or downloaded via a communications port in order to determine signal characteristics that can be used to identify the local RF sources of the radio frequency signals.

Advantageously, the detector includes a display for displaying the identities of the local RF sources so that scope interpretation and RF signal knowledge, such as that required for operating oscilloscopes and spectrum analyzers, is not required to identify a known source of a received RF signal. Additionally, the detector is easily hand transportable and can be carried around a physical space while monitoring the displayed signal reception level so that regions of higher and lower levels of RF interference and the physical location of a local RF source may be easily determined.

In one form, the invention provides a radio frequency source detector for identifying and locating local sources of radio frequency signals, including a receiver adapted to receive radio frequency signals in a predetermined band from at least one type of local radio frequency source, a processor coupled to the receiver and having an analysis circuit capable of analyzing the radio frequency signals in the frequency and/or time domain to determine the identity of the local sources of the radio frequency signals, and a display coupled to the processor and adapted to display the identities.

In another form, the invention includes a signal processing system for identifying and locating local sources of radio frequency signals, including a receiver adapted to receive radio frequency signals in a predetermined band from at least one type of local radio frequency source, a user interface, and a processor coupled to the receiver and the user interface and having software enabling the processor to receive radio frequency signals in the predetermined band and analyze the signals in the time and/or frequency domain to determine and display the identity of at least one local source of the signals.

In yet another form, the invention provides a method for identifying local radio frequency sources, including the steps of receiving radio frequency signals in a predetermined band from the local radio frequency sources, measuring signal characteristics of the radio frequency signals in the time domain, matching the measured signal characteristics to signal characteristics of known radio frequency sources, and providing the identities of matching known radio frequency sources.

### BRIEF DESCRIPTION OF THE DRAWINGS

The above-mentioned and other features and advantages of this invention, and the manner of attaining them, will become more apparent and the invention itself will be better understood by reference to the following description of an embodiment of the invention taken in conjunction with the accompanying drawings, wherein:

FIG. 1 is a schematic block diagram of an RF source detector according to the present invention;

FIGS. 2A and 2B are perspective views of embodiments of the RF source detector of FIG. 1; and

FIGS. 3A-3E show a flow diagram illustrating the steps of identifying the source of received RF signals according to the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DETAILED DESCRIPTION

The embodiment disclosed below is not intended to be exhaustive or limit the invention to the precise form disclosed in the following detailed description. Rather, the embodiment is chosen and described so that others skilled in the art may utilize its teachings.

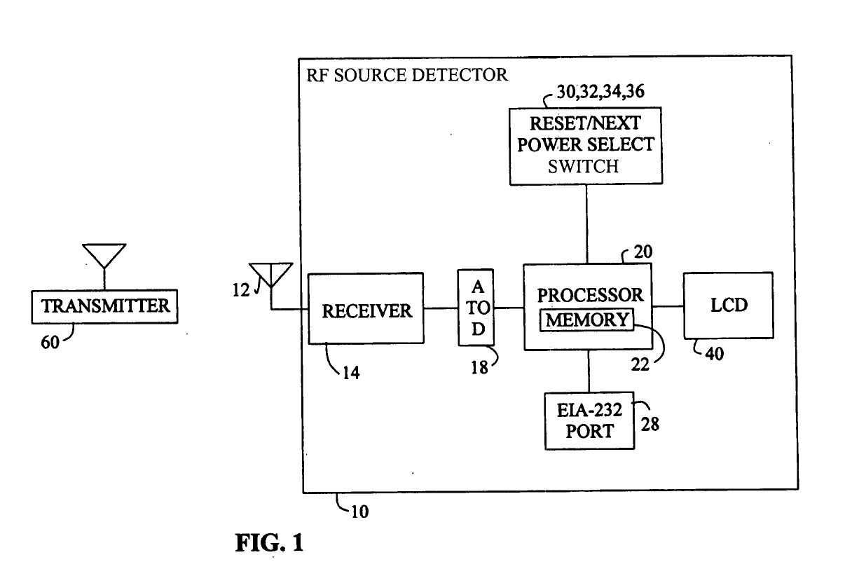

Referring to FIG. 1, an exemplary embodiment of RF source detector 10 is shown. RF source detector 10 detects the local sources of RF signals or interference, such as RF transmitter source 60, and receives and analyzes RF signals in order to determine the identities or types of RF sources 60.

RF source detector 10 includes antenna 12, receiver 14, and analog-to-digital converter (A/D converter) 18, which receive and provide digital samples of RF signals to processor 20. Processor 20 includes memory 22 and is coupled to user interfaces including liquid crystal display (LCD) 40, reset switch 36, next switch 32, power switch 30, select switch 34, and communications port 28.

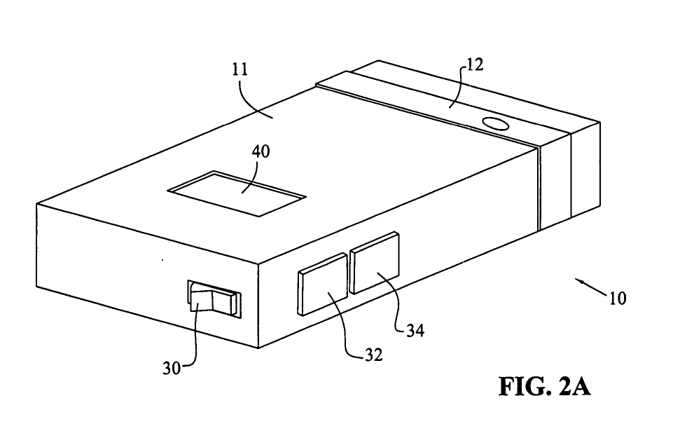

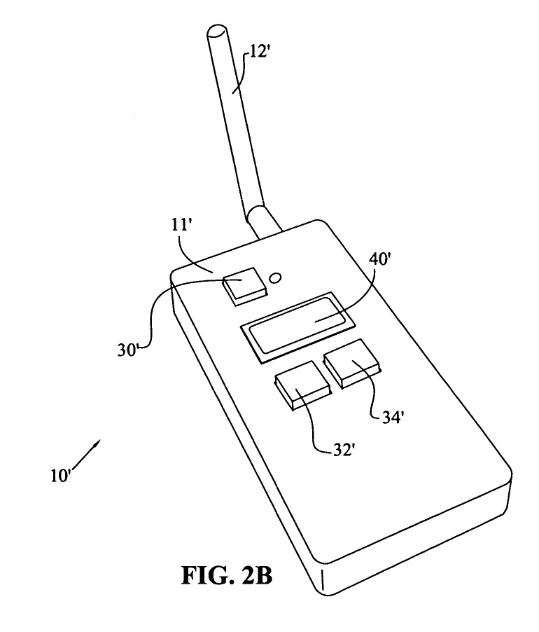

Referring to FIGS. 2A and 2B, the exemplary embodiments of RF source detector 10 (FIG. 2A) and 10′ (FIG. 2B) includes a handheld case 11, 11′ containing the various components of the detection circuit and supporting power switch 30, 30′, next switch 32, 32′, select switch 34, 34′, and LCD 40, 40′.

Antenna 12, in the exemplary embodiment of FIG. 2A, is a dielectric element antenna which is coupled to receiver 14. Antenna 12 may be, for example, Part No. DAC2450CT1, manufactured by Toko America, Inc., of Mt. Prospect, Ill. Alternatively, as shown in FIG. 2B, antenna 12′ may be a whip antenna, such as Part No. 5131AM-24SOS, available from Nearson, Inc., of Springfield, Va.

Receiver 14 is a wide band receiver capable of receiving RF signals and interference over a predetermined frequency range, such as, for example, 2400 MHz to 2500 MHz or other such frequency ranges suitable for detecting sources of interference for devices operating in other frequency bands. Such a receiver may be implemented as is known in the art, for example, by utilizing low noise amplifier 50, such as Part No. MAX 2641, available from Maxim Integrated Products, Inc., of Sunnyvale, Calif.; mixer 52, such as Part No. MAX 2680, available from Maxim; local oscillator 54, such as Part No. V42100, available from M/A-COM SIGINT Products, Tyco Electronics, Hunt Valley, Md.; and logarithmic amplifier detector 56, such as Part No. AD8307 using successive detection, available from Analog Devices, Inc., of Norwood, Mass. The particular implementation of receiver 14 is dependent on the band being detected, the relevant signal characteristics, size and expense considerations, etc.

The RF signals are received by receiver 14, down converted to 350-450 MHz, by mixer 52 and local oscillator 54, the wide dynamic range signal is converted to its decibel equipment by logarithmic amplifier/detector 56, and is then provided to A/D converter 18. A/D converter 18 provides digital signal samples to processor 20. A/D converter 18 provides a sample rate of the RF signals of at least 1,000 samples per second. A/D converter 18 may be implemented as is known in the art, may be included in receiver 14 or processor 20, or by utilizing an IC such as Part No. ADC08832, manufactured by National Semiconductor, of Santa Clara, Calif.

Processor 20 may be a digital signal processor (DSP) or other processor having circuitry or software for performing fast fourier transforms (FFTs) on the received RF signals. Processor 20 may also include memory 22, for example, flash memory, for storing software, a table of signal characteristics of known local RF source devices, and data sets of received RF signals and computed statistics and FFTs. Software enables processor 20 to receive, analyze, identify, and display the sources of the received RF signals. Alternatively, processor 20 may be implemented solely with discrete circuitry to enable such functions, or a combination of software and circuitry. Processor 20 may be, for example, Part No. BS2P, available from Parallax, of Melville, N.Y. Alternatively, processor 20 may include A/D converter 18 such as with integrated circuit MSP430F148 available from Texas Instruments, of Dallas, Tex.

Processor 20 is coupled to user interfaces, including switches 30, 30′, 32, 32′, 34, 34′, 36 and 36′; LCD 40, 40′; and communications port 28. LCD 40, 40′ may have, for example, two lines for displaying menu selections, the identity of detected RF sources 60, and characteristics of received RF signals. Such an LCD may be, for example, Part No. DMC-SO448N-E-AE, available from Optrex America, Inc., of Plymouth, Mich.

Input switches include power selector switch 30, 30′ for turning power on and off to RF source detector 10, reset switch 36 for resetting the software and/or hardware of RF source detector 10, next switch 32, 32′ for advancing the software of processor 20 to the next detection mode, and select switch 34, 34′ for selecting the currently displayed menu item or detection mode.

RF source detector 10, 10′ may also include communications port 28 coupled to processor 20. Communications port 28 may be an EIA-232 communications port, or other communications port or network connection suitable for transferring data from RF source detector 10 to a computing device, such as a personal computer.

source detector 10, 10′ includes a number of operating modes for analyzing, identifying, and locating RF sources 60. Generally, the modes enable RF source detector 10, 10′ to identify the type of device generating RF signals or interference, to display signal levels in order to determine the physical location of RF source 60 or to locate areas of stronger or weaker signals or interference, and to capture, store, and transmit, via communications port 28, data sets relating to RF signals received from RF source 60. For example, RF source detector 10, 10′ may be used for detecting and determining sources of interference when installing or troubleshooting local communication systems, such as WLANs, or for collecting data for developing an algorithm that identifies an RF source based on RF signal characteristics.

The Looking Mode of RF source detector 10, 10′ will display “looking” on LCD 40, 40′ until at least one RF source 60 is identified. Upon identification, LCD 40, 40′ will display the identity or type of RF source 60 and the peak and average signal levels. Such signal levels may be displayed as words (e.g., “weak,” “moderate,” “strong,” “extreme”), as graphics (e.g., pie or bar charts), or with a numeric display. Types of RF signals that may be identified, based on signal characteristics in both the time and frequency domain, include cordless phones, microwave ovens, WLANs, short-range wireless devices such as Bluetooth™, and wireless video transmitters.

A typical use for RF source detector 10, 10′ is to identify and locate sources of interference when installing or troubleshooting a WLAN or other local communication system. For example, by identifying and locating RF source 60 which generates an RF signal that interferes with a WLAN, RF source 60 may be relocated or shielded, a different operating frequency could be selected for the WLAN, or one or more components of the WLAN could be relocated or shielded from the offending RF source. When more than one RF source 60 is received by RF source detector 10, 10′, detector 10, 10′ will identify and display source 60 producing the strongest signal received by detector 10, 10′. Alternatively, RF source detector 10, 10′ may be configured to identify multiple RF sources, using the methods described below iteratively.

The Received Signal Level Mode of RF source detector 10, 10′ is operable to display the word “Received” and the received signal level in decibels with respect to miliwatts (dBm). The Received Signal Level Mode is useful for physically locating transmitters, especially those emitting a steady signal level. Additionally, the Received Signal Level Mode may be used to locate areas having stronger or weaker RF signals or interference.

The Min and Max Mode of RF source detector 10, 10′ is operable to display the minimum and maximum signal levels received during the previous 500 ms. The maximum and minimum signal levels are displayed in dBm. The Min and Max Mode of RF source detector 10, 10′ is useful to determine signal-to-noise ratio of the RF signal received by detector 10, 10′, and for physically locating RF source 60.

The Capture and Dump FFT Mode of RF source detector 10, 10′ is operable to capture data sets, such as a 64-point or 512-point data set, of a received RF signal at a sampling rate that is determined by the software of source detector 10, 10′, for example 1,184 samples per second. Additionally, the Capture and Dump FFT Mode of RF source detector 10, 10′ is operable to perform an FFT of a captured data set and store the collected and FFT data sets in memory 22. After capturing and performing an FFT, LCD 40, 40′ will display “dump FFT,” prompting the user to actuate select switch 34, 34′ in order to transmit the stored data sets through communications port 28.

The Capture and Dump Mode of RF source detector 10, 10′ is operable to collect a data set, for example of 1,024 points, of the received RF signal at a sampling rate that is determined by the software of source detector 10, 10′, for example 768 samples per second. The data set may be stored in memory 22, and upon display of “dump” on LCD 40, 40′ and selection by the user, the data set may be transmitted through communications port 28.

The Capture and Dump Statistics Mode of RF source detector 10, 10′ is operable to capture, store, and transmit statistical information relating to the received RF signal. The Capture and Dump Statistics Mode captures up to 256 data sets of statistics relating to the received RF signal. Each data set includes 127 samples of the RF signal that are used to calculate the minimum, maximum, and average signal levels at a variable sample rate, for example 768 samples per second. After display of the “dump” prompt and selection by the user, the capture and dump statistics mode provides transmission of the statistical data sets through communications port 28.

The various capture and dump modes of RF source detector 10, 10′ are useful for providing a data set to an external device, such as a computer, which may then be used to develop new algorithms for identifying RF sources 60. Algorithms examine various signal characteristics in the time or frequency domain in order to identify RF source 60 associated with a received RF signal. For example, Table 1 lists typical identifying characteristics associated with several types of RF sources 60.

TABLE 1

| | Time or | |
|---|---|---|
| | Frequency | |
| Transmitter Type | Domain | Signal Characteristics |
| WLAN | Time | Beacon transmission with |
| | | SSID and other |
| | | information: may be 2 or |
| | | 3 samples long, or the |
| | | level of a pulse, one |
| | | sample time long, being |
| | | greater than 6 times the |
| | | average signal level, or |
| | | other protocol. |
| Video Transmitter | Time | The ratio of maximum |
| | | signal level to minimum |
| | | signal level is |
| | | approximately 1 and the |
| | | signal level exceeds a |
| | | threshold. |
| Microwave Oven | Frequency | A peak at 120 or 60 Hz |
| | | (US); or a peak at 100 or |
| | | 50 Hz (Europe). |
| Cordless Phone | Frequency | A peak at 500 Hz. |
| Short Range | Frequency | A peak at 800 Hz. |
| Wireless | | |

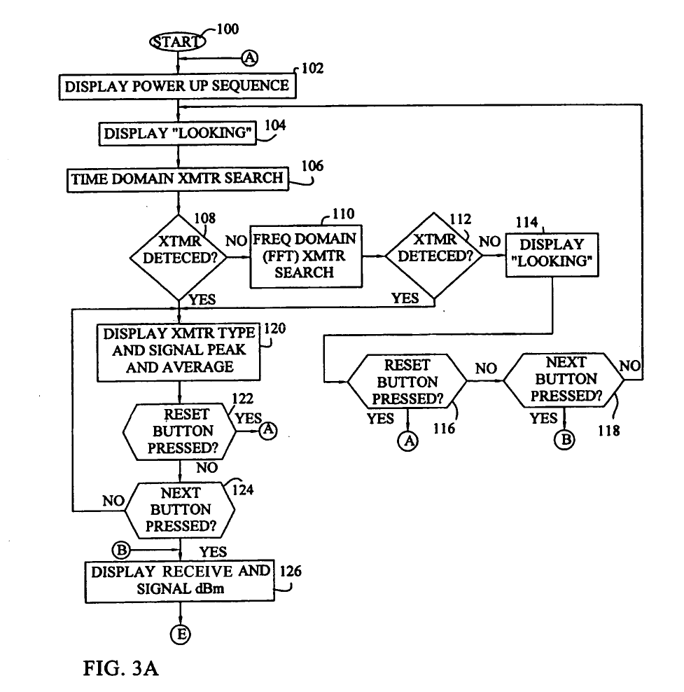

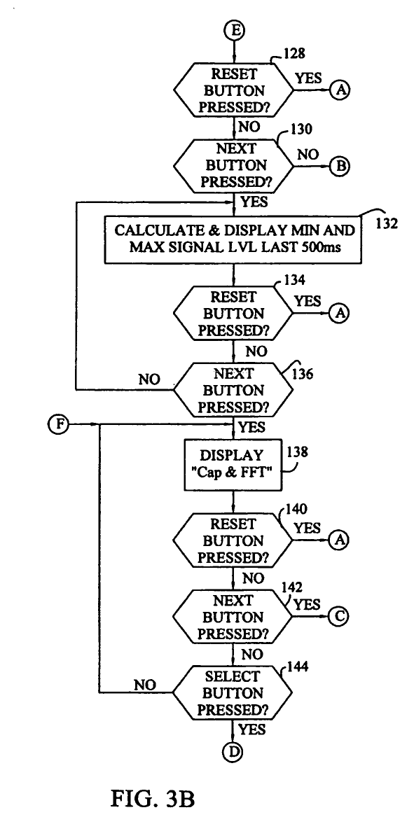

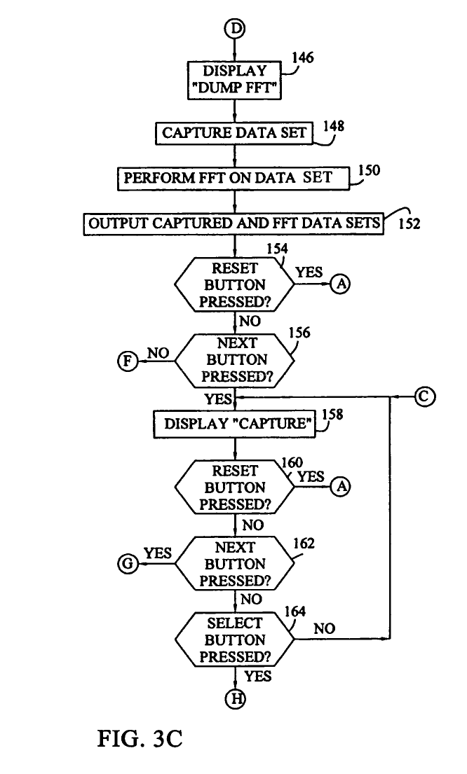

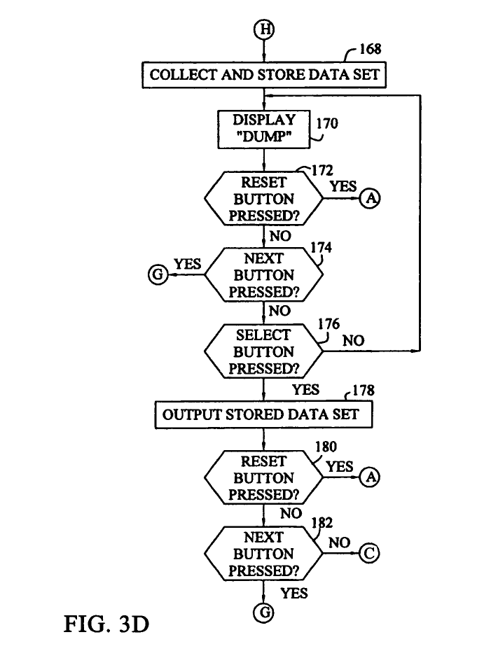

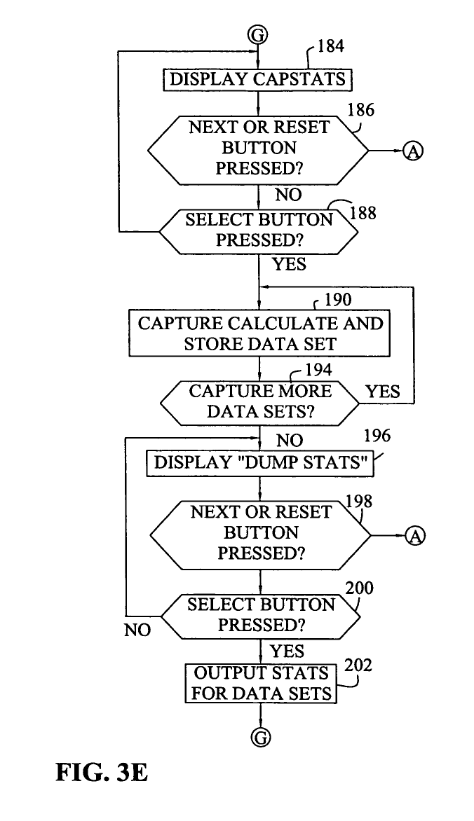

Referring to FIGS. 3A-E, method 100 is implemented in the exemplary embodiment by software, processor 20, and the associated components, such as those shown in FIG. 1. Method 100 implements the various operating modes discussed above for receiving, analyzing, and identifying the source of RF signals associated with RF source 60. Method 100 is completed upon power-up of RF source detector 10, 10′, by actuation of power switch 30, 30′. In step 102, processor 20 displays a power-up sequence on LCD 40, for example, a sequential series of identifying text such as “Wireless Infield, “Wireless Umpire,” and “Version XXX.”

The Looking Mode of RF source detector 10 is implemented by steps 104 to 124. In step 104, processor 20 displays “looking” on LCD 40. In step 106, processor 20 completes a time domain transmitter analysis through the predetermined frequency band. Processor 20 receives RF signals through antenna 12, 12′, receiver 14, and A/D converter 18. In step 108, processor 20 compares measured RF signal characteristics with signal characteristics of known RF sources 60, for example, as shown in Table 1. If processor 20 matches an RF signal with a known RF source, then step 120 is completed, else step 110 is completed.

In step 110, processor 20 completes a frequency domain transmitter search by processing the received RF signals with an FFT algorithm. The algorithm may be completed by discreet DSP circuitry, by software enabling processor 20, or by a combination of discrete circuitry and software. In step 112, processor 20 will again attempt to match the measured characteristics with characteristics of known RF sources 60. If processor 20 determines a match, step 120 is completed, else step 114 is completed.

In step 114, processor 20 again displays “looking” on LCD 40. In step 116, processor 20 determines whether the user has actuated reset switch 36. If reset switch 36 has been actuated, method 100 continues at step 101, else step 118 is completed. In step 118, processor 20 determines whether next switch 32 has been actuated. If next switch 32 has been actuated, method 100 continues at step 126, the next operating mode, else the Looking Mode continues at step 104.

If in steps 108 or 112 processor 20 detects a known RF source identity, then in step 120, processor 20 displays the identity of RF source 60 and the received signal peak and average levels (for example, by displaying text). In step 122, processor 20 determines whether reset switch 36 has been actuated. If reset switch 36 has been actuated, method 100 continues at step 104, else step 124 is completed. In step 124, processor 20 determines whether next switch 32 has been actuated. If next switch 32 has been actuated, the next operating mode is completed beginning at step 126, else the Looking Mode continues to display the transmitter type and received signal peak and average at step 120.

The Received Signal Level Mode is implemented by steps 126 to 130. In step 126, processor 20 displays “received” and the received signal level in decibels with respect to miliwatts, dBm. Referring to FIG. 3B, in step 128, processor 20 determines whether reset switch 36 has been actuated. If reset switch 36 has been actuated, method 100 continues at step 102, else step 130 is completed. In step 130, processor 20 determines whether next switch 32 has been actuated. If next switch 32 has been actuated, the next operating mode is selected beginning at step 132, else processor 20 continues to display the received signal dBm at step 126.

The Min and Max Mode is implemented by steps 132 to 136. In step 132, processor 20 calculates the minimum and maximum signal levels received in the last 500 ms and displays those levels on LCD 40. In step 134, processor 20 determines whether reset switch 36 has been actuated. If reset switch 36 has been actuated, method 100 continues at step 102, else step 136 is completed. In step 136, processor 20 determines whether next switch 32 has been actuated. If next switch 32 has been actuated, the next operating mode is initiated in step 138, else processor 20 continues to calculate and display minimum and maximum signal levels at step 132.

The Capture and Dump FFT Mode is implemented by steps 138 to 156. In step 138, processor 20 displays “Cap&FFT” on LCD 40, prompting the user to activate the Capture and Dump FFT Mode by actuating select switch 34. In step 140, processor 20 determines whether reset switch 36, 36′ has been actuated. If reset switch 36, 36′ has been actuated, method 100 continues at step 102, else step 142 is completed. In step 142, processor 20 determines whether next switch 32, 32′ has been actuated. If next switch 32, 32′ has been actuated, the next operating mode is initiated at step 158, else step 144 is completed.

In step 144, processor 20 determines whether select switch 34, 34′ has been actuated. If select switch 34, 34′ has been actuated, processor 20 captures and dumps RF signal samples and FFT data sets beginning at step 146 (FIG. 3C), else the Capture and Dump FFT Mode continues to wait for a switch actuation beginning at step 138. In step 146, processor 20 displays “dump FFT” on LCD 40, 40′. In step 148, processor 20 captures a data set of 64 RF signal samples and stores the data set in memory 22. In step 150, processor 20 performs an FFT on the captured data set and stores the results in an FFT data set in memory 22. In step 152, processor 20 outputs the captured and FFT data sets on a user interface, for example, communications port 28. The exemplary embodiment formats the data and 64 records of five fields each. The first field is the sample number, the second field is the data captured, the third number is −128, the fourth number is the real part of the FFT, and the fifth number is the imaginary part of the FFT. In step 154, processor 20 determines whether reset switch 36, 36′ has been actuated. If reset switch 36, 36′ has been actuated, method 100 continues at step 102, else step 156 is completed. In step 156, processor 20 determines whether next switch 32, 32′ has been actuated. If next switch 32, 32′ has been actuated, the next operating mode is completed beginning at step 158, else the Capture and Dump FFT Mode is restarted at step 138.

The Capture and Dump Mode is implemented in steps 158 to 182. In step 158, processor 20 displays “Capture” on LCD 40, 40′ to prompt the user to actuate select button 32, 32′ to capture and dump an RF signal data set. In step 160, processor 20 determines whether reset switch 36 has been actuated. If reset switch 36 has been actuated, method 100 continues at step 102, else step 162 is completed. In step 162, processor 20 determines whether next switch 32, 32′ has been actuated. If next switch 32, 32′ has been actuated, the next operating mode begins at step 184, else step 164 is completed. In step 164, processor 20 determines whether select switch 32, 32′ has been actuated. If select switch 34, 34′ has been actuated, processor 20 collects and stores the data set beginning at step 168, else processor 20 continues to wait for a switch actuation at step 158.

Referring to FIG. 3D, in step 168, processor 20 captures a data set (for example, a 124 RF signal samples) and stores the data set in memory 22 at a sampling rate determined by software (for example, 768 samples per second). In step 170, processor 20 displays “dump” on LCD 40, 40′ to prompt the user to actuate select switch 64 to output the stored data set via communications port 28. In step 172, processor 20 determines whether reset switch 36 has been actuated. If reset switch 36 has been actuated, method 100 continues at step 102, else step 174 is completed. In step 174, processor 20 determines whether next switch 32, 32′ has been actuated. If next switch 32, 32′ has been actuated, the next operating mode begins at step 184, else step 176 is completed. In step 176, processor 20 determines whether select switch 34, 34′ has been actuated. If select switch 34, 34′ has been actuated, step 178 is completed, else processor 20 continues to wait for a switch actuation beginning at step 170.

In step 178, the stored data set is output to a user interface, for example, communications port 28. In step 180, processor 20 determines whether reset switch 36 has been actuated. If reset switch 36 has been actuated, method 100 continues at step 102, else step 182 is completed. In step 182, processor 20 determines whether next switch 32, 32′ has been actuated. If next switch 32, 32′ has been actuated, the next operating mode begins at step 184, else the capture and dump mode is restarted at step 158.

Referring to FIG. 3E, Capture and Dump Statistics Mode is implemented by steps 184 to 202. In step 184, processor 20 displays “CapStats” on LCD 40, 40′. In step 186, processor 20 determines whether next switch 32, 32′ or reset switch 36 has been actuated. If so, method 100 continues at step 102, else step 188 is completed. In step 188, processor 20 determines whether select switch 34, 34′ has been actuated. If select switch 34, 34′ has been actuated, then step 190 is completed, else processor 20 continues to wait for a switch actuation at step 184. In step 190, processor 20 captures and stores a data set of the minimum, maximum, and average levels of 127 samples of the RF signal sampled at a rate determined by software (for example, 768 samples per second). In step 194, processor 20 determines whether or not 256 data sets have been stored, if not, step 190 is repeated until 256 data sets have been stored. When step 194 determines that 256 data sets have been captured, step 196 is completed.

In step 196, processor 20 displays “DmpStats” on LCD 40, 40′, prompting the user to actuate select button 34, 34′ to output the data sets to a user interface. In step 198, processor 20 determines whether next switch 32, 32′ or reset switch 36 have been actuated. If so, method 100 continues at step 102, else step 200 is completed. In step 200, processor 20 determines whether select switch 34, 34′ has been actuated. If select switch 34, 34′ has been actuated, step 202 is completed, else processor 20 continues to wait for a user switch actuation at step 196. In step 202, processor 20 outputs the stored statistical data sets via communications port 28. After step 202 is completed, the capture and dump statistics mode is restarted at step 184.

Method 100 will be completed until power switch 30, 30′ is actuated to the off position.

While this invention has been described as having an exemplary design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A radio frequency source detector for identifying local sources of radio frequency signals, comprising:
a receiver adapted to receive radio frequency signals;
a processor coupled to said receiver and having an analysis circuit capable of determining the level of the radio frequency signals in at least one of the frequency and time domain to determine the identity of the local sources of the radio frequency signals; and
a display coupled to said processor and adapted to display the identities.

2. The radio frequency source detector of claim 1, further comprising an analog to digital converter coupled to said receiver and to said processor.

3. The radio frequency source detector of claim 1, wherein said processor is adapted to collect or calculate samples, statistics, and FFTs of the radio frequency signals.

4. The radio frequency source detector of claim 1, wherein the identities of the local radio frequency sources are selected by said processor from a group including at least WLANs, video transmitters, microwave ovens, cordless phones, and short-range wireless devices.

5. The radio frequency source detector of claim 1, wherein said processor includes circuitry or software that measures at least one of minimum, maximum, and average signal level of the radio frequency signals and identifies the local radio frequency sources based on the measurements.

6. The radio frequency source detector of claim 1, wherein said processor includes circuitry or software that measures peak power frequencies of the radio frequency signals in the frequency domain and identifies the radio frequency sources based on the measurements.

7. The radio frequency source detector of claim 1, wherein said processor includes circuitry or software that measures the signal level of the radio frequency signals and identifies at least one radio frequency source as a WLAN upon the radio frequency signals having a single sample signal level greater than six times an average signal level.

8. The radio frequency source detector of claim 1, wherein said processor includes circuitry or software that measures the signal level of the radio frequency signals and identifies at least one radio frequency source as a video transmitter upon the radio frequency signals having a maximum to minimum signal level ratio of approximately one and an average signal level above a threshold.

9. The radio frequency source detector of claim 1, wherein said processor includes circuitry or software that measures the peak power frequencies of the radio frequency signals in the frequency domain and identifies at least one radio frequency source as a microwave oven upon the radio frequency signals having a peak power at approximately 50, 60, 100, and 120 Hz.

10. The radio frequency source detector of claim 1, wherein said processor includes circuitry or software that measures the peak power frequency of the radio frequency signals in the frequency domain and identifies at least one radio frequency source as a cordless phone upon the radio frequency signals having a peak power at approximately 500 Hz.

11. The radio frequency source detector of claim 1, wherein said processor includes circuitry or software that measures the peak power frequency of the radio frequency signals in the frequency domain and identifies at least one radio frequency source as a short-range wireless device upon the radio frequency signals having a peak power at approximately 800 Hz.

12. The radio frequency source detector of claim 1, wherein said processor includes circuitry or software that measures and displays signal level in decibels on said display.

13. The radio frequency source detector of claim 1, wherein said processor includes circuitry or software that measures and displays minimum and maximum signal levels on said display.

14. The radio frequency source detector of claim 1, further comprising a communications port and wherein said processor has circuitry or software that captures and outputs to said communications port a data set relating to the radio frequency signals.

15. The radio frequency source detector of claim 1, wherein said processor includes circuitry or software that calculates fast fourier transform (FFT) data for said data set and outputs said FFT data to said communications port.

16. The radio frequency source detector of claim 1, wherein said processor includes circuitry or software that calculates statistics relating to said data set and output said statistics to said communications port.

17. The radio frequency source detector of claim 1, wherein said predetermined band includes those radio frequencies capable of interfering with a WLAN.

18. A radio frequency source detector for identifying and locating local sources of radio frequency signals, comprising:
a receiver adapted to receive radio frequency signals in a predetermined band from at least one type of local radio frequency source;
a user interface; and
a processor coupled to said receiver and said user interface and having software enabling said processor to receive radio frequency signals in the predetermined band and determine the level of the signals in at least one of the time and frequency domain to determine and display the identity of at least one local source of the signals.

19. The radio frequency source detector of claim 18, wherein said software further enables said processor to
access a data table of typical signal characteristics of the radio frequency signals associated with a type of local radio frequency source;
measure the signal characteristics of the radio frequency signals received by said receiver in the time and frequency domains;
determine the type of local radio frequency sources transmitting the radio frequency signals by comparing the measured signal characteristics with said data table; and
output the type of local radio frequency source to said user interface.

20. The radio frequency source detector of claim 18, wherein the predetermined band includes radio frequencies and signals capable of interfering with a WLAN.

21. The radio frequency source detector of claim 19, wherein the types of local radio frequency sources included in said data table include at least one of a WLAN, a video transmitter, a microwave oven, a cordless phone, and a short-range wireless device.

22. The radio frequency source detector of claim 18, wherein said software further enables said processor to determine and output to said user interface at least one of a minimum, a maximum and an average signal level of said radio frequency signals.

23. The radio frequency source detector of claim 18, wherein said software further enables said processor to create a data set of samples of said radio frequency signals and to output said data set via said user interface.

24. The radio frequency source detector of claim 23, wherein said data set includes an FFT of said samples.

25. The radio frequency source detector of claim 23, wherein said data set includes statistics of said samples.

26. The radio frequency source detector of claim 18, wherein said user interface and said processor are adapted to receive an upgrade to said software.

27. The radio frequency source detector of claim 26, wherein said upgrade amends said data table of typical signal characteristics to include additional types of local radio frequency sources.

28. A method for identifying local radio frequency sources, comprising the steps of:
receiving radio frequency signals in a predetermined band from the local radio frequency sources;
determining the level and signal characteristics of the radio frequency signals in the time domain;
matching the measured signal characteristics to signal characteristics of known radio frequency sources; and
providing the identities of matching known radio frequency sources.

29. The method of claim 28, further comprising the step of measuring signal characteristics of the radio frequency signals in the frequency domain.

30. The method of claim 28, wherein the predetermined band includes frequencies and signals capable of interfering with a WLAN.

31. A method of improving detection of local radio frequency sources by a radio frequency source detector, comprising the steps of:
collecting a data set including at least one of samples, statistics and FFTs of radio frequency signals;
analyzing the data set to determine signal characteristics for identifying local radio frequency sources; and
appending the signal characteristics and identities of the radio frequency sources to a table of known local radio frequency sources.
